(19) United States
(12) Patent Application Publication
(10) Pub. No.: US 2016/0319219 A1
(43) Pub. Date: Nov. 3, 2016

(54) IMPROVED VEGETABLE FAT

(71) Applicant: AAK AB (publ), Malmö (SE)

(72) Inventor: Morten Daugaard ANDERSEN, Højbjerg (DK)

(21) Appl. No.: 15/103,476

(22) PCT Filed: Dec. 10, 2014
(86) PCT No.: PCT/SE2014/051478

§ 371 Date: Jun. 10, 2016

(30) Foreign Application Priority Data
Dec. 10, 2013 (SE) 1351476-5
Apr. 8, 2014 (SE) 1450432-8

(51) Int. Cl. C11B 7/00; A23G 1/36; A23D 9/04

(52) U.S. Cl. CPC C11B 7/0075; A23D 9/04; A23G 1/36; A23V 2002/00

(57) ABSTRACT

The invention relates to a method of increasing a main endotherm melt peak position of a vegetable fat or fractions thereof to an increased value compared to a starting value, said increased value being about 40° C. or higher, said main endotherm melt peak position being measured by Differential Scanning Calorimetry by heating samples of 10±1 mg of said vegetable fat or fraction thereof from 20° C. to 50° C. at a rate of 3° C./min to produce a melting thermogram defining said main endotherm melt peak position, the method comprising the steps of: a) melting the vegetable fat or fractions thereof by applying heat, b) storing the vegetable fat or fractions thereof at a temperature below said increased value of main endotherm melt peak position for at least 5 hours, whereby an increase in said main endotherm melt peak position for said vegetable fat or fractions thereof is obtained when compared to said starting value, wherein said vegetable fat or fractions thereof comprises SatOSat-triglycerides in an amount of 40-95% by weight, wherein said vegetable fat or fractions thereof comprises StOSt-triglycerides in an amount of 30-85% by weight, and wherein Sat stands for a saturated fatty acid, St stands for stearic acid and O stands for oleic acid.

### FIELD OF THE INVENTION

The invention relates to the field of vegetable fats.

In particular the invention relates to a method for obtaining high-melting vegetable fat crystals. The invention also relates to chocolate products comprising such improved vegetable fat.

### BACKGROUND

Vegetable fats are part of a wide variety of foodstuff and are also used in cosmetic- and pharmaceutical products.

Vegetable fats can be viewed as a blend of triglycerides and small amounts of other substances. The chemical composition of the triglycerides depends on the source of the vegetable fat or oil and may be modified by processing of the vegetable fat.

The solid part of a vegetable fat at a certain temperature comprises fat crystals made of triglycerides. The crystallization behavior of blends of triglycerides is complex and not fully understood. Different crystal forms of varying stability are known to form during fat solidification. The most stable crystal forms will have the highest melting point.

In many applications it is important to obtain good melting properties of the vegetable fat, because those properties influence both sensory parameters and the overall temperature stability of the vegetable fat.

During chocolate production the chocolate composition, including vegetable fat like cocoa butter, is normally subjected to a so-called tempering process to promote the formation of desirable amounts of stable fat crystals that are important for good mouth-feel and shelf life.

The tempering process is performed in a tempering apparatus in which the chocolate is subjected to a carefully pre-programmed temperature profile.

Subsequently, the chocolate is used for making the chocolate confectionary and the resulting confectionary is cooled following a predetermined cooling program.

The tempering process serves the purpose of making a sufficient amount of a desired type of seed crystals, which in turn is responsible for obtaining a rather stable chocolate product less prone to changes in the crystal composition of the solid fats.

An addition or an alternative to the tempering process is to blend pre-formed seed crystals of a desired form into the chocolate during the manufacturing process. Sato et al., JAOCS, Vol. 66, no. 12, 1989, describe the use of crystalline seed to accelerate the crystallization going on in cocoa butter and dark chocolate upon solidification.

JP 2008206490 discloses a tempering promoter in the form of SatUSat-type triglycerides, where Sat is a saturated fatty acid having 20 or more carbon atoms and U is an unsaturated fatty acid such as oleic acid.

EP 0 294 974 A2 describes a powdery tempering accelerator also based on SatUSat-type triglycerides having a total number of carbon atoms of the constituent fatty acid residues of between 50 and 56. The tempering accelerator is added, for example, as dispersion in a dispersion medium, as a seed for desired crystal formation to the chocolate during the production.

There still exists a need for methods to improve the crystallization behaviour in vegetable fat.

### SUMMARY OF THE INVENTION

The invention pertains to a method of increasing a main endotherm melt peak position of a vegetable fat or fractions thereof to an increased value compared to a starting value, said increased value being about 40° C. or higher, said main endotherm melt peak position being measured by Differential Scanning Calorimetry (DSC) by heating samples of 10±1 mg of said vegetable fat or fraction thereof from 20° C. to 50° C. at a rate of 3° C./min to produce a melting thermogram defining said main endotherm melt peak position, the method comprising the steps of:

a) melting the vegetable fat or fractions thereof by applying heat,

b) storing the vegetable fat or fractions thereof at a temperature below said increased value of said main endotherm melt peak position for at least 5 hours,

whereby an increase in said main endotherm melt peak position for said vegetable fat or fractions thereof is obtained when compared to said starting value,

wherein said vegetable fat or fractions thereof comprises SatOSat-triglycerides in an amount of 40-95% by weight,

wherein said vegetable fat or fractions thereof comprises StOSt-triglycerides in an amount of 30-85% by weight, and

wherein Sat stands for a saturated fatty acid, St stands for stearic acid and O stands for oleic acid.

In an embodiment of the temperature applied in step b) is about 25° C. to about 39° C., such as about 27° C. to about 39° C., about 30° C. to about 39° C. or about 33° C. to about 38° C.

In an embodiment of the invention the method is further comprising a step a1) following step a) and prior to step b), said the step a1) consisting of cooling the vegetable fat or fractions thereof to a temperature of between about −30° C. and about 39° C., such as between about −10° C. and about 38° C. or between about 0° C. and about 37° C.

In an embodiment of the invention said vegetable fat or fractions thereof comprises SatOSat in an amount of 50-93% by weight, such as 60-90% by weight.

In an embodiment of the invention said vegetable fat or fractions thereof comprises StOSt in an amount of 40-80% by weight, such as 45-75% or 50-70%.

In an embodiment of the invention said vegetable fat or fractions thereof is selected from the group consisting of shea, sal, mango, mowra, kokum, illipe, cupuacu and any combination thereof.

In an embodiment of the invention said vegetable fat or fractions thereof comprises or consists of shea stearin.

In an embodiment of the invention said increased value of said main endotherm melt peak position is about 41° C. or higher, such as about 42° C. or higher or about 43° C. or higher.

In an embodiment of the invention said increased value of said main endotherm melt peak position is at least about 2° C., such as at least about 3° C. or at least about 4° C. above said starting value.

In an embodiment of the invention step b) is performed for at least about 10 hours such as for at least about 14 hours or for at least about 18 hours.

The invention further relates to a chocolate product comprising the vegetable fat or fractions thereof manufactured according to the method of any of the embodiments described above.

The invention also relates to use of the vegetable fat or fractions thereof manufactured according to the method of any of the embodiments described for production of chocolate products.

The invention further relates to use of the vegetable fat or fractions thereof manufactured according to the method of any of the embodiments described for production of chocolate products, said vegetable fat or fractions thereof being used as a seed.

### DETAILED DESCRIPTION

The invention is now described in more detail and specific embodiments of the invention are described by way of examples.

The following definitions and abbreviations apply throughout the description:

Sat=saturated fatty acid/acyl-group

U=unsaturated fatty acid/acyl-group

St=stearic acid/stearate

O=oleic acid/oleate

DSC=Differential Scanning Calorimetry

CBE=Cocoa butter equivalent

CBI=Cocoa butter improver

In the present context, the term “high melting” means melting at a high temperature.

In the present context amounts given as percentage (%) are by weight (w/w, wt %, wt. %) unless stated otherwise.

In chocolate production it may be important to obtain good melting properties of the vegetable fat comprised in the chocolate, because those properties influence both sensory parameters and the overall temperature stability of the vegetable fat.

It is often beneficial to add vegetable fat to the cocoa butter in chocolate to adjust the properties of the chocolate in a desired way.

The invention pertains to a method of increasing a main endotherm melt peak position of a vegetable fat or fractions thereof to an increased value compared to a starting value, said increased value being about 40° C. or higher, said main endotherm melt peak position being measured by Differential Scanning Calorimetry (DSC) by heating samples of 10±1 mg of said vegetable fat or fraction thereof from 20° C. to 50° C. at a rate of 3° C./min to produce a melting thermogram defining said main endotherm melt peak position, the method comprising the steps of:

a) melting the vegetable fat or fractions thereof by applying heat,

b) storing the vegetable fat or fractions thereof at a temperature below said increased value of said main endotherm melt peak position for at least 5 hours,

whereby an increase in said main endotherm melt peak position for said vegetable fat or fractions thereof is obtained when compared to said starting value,

wherein said vegetable fat or fractions thereof comprises SatOSat-triglycerides in an amount of 40-95% by weight,

wherein said vegetable fat or fractions thereof comprises StOSt-triglycerides in an amount of 30-85% by weight, and

wherein Sat stands for a saturated fatty acid, St stands for stearic acid and O stands for oleic acid.

The main endotherm melt peak position is an excellent measure of the melting properties of a vegetable fat. DSC is a widely used method to characterize the melting properties of vegetable fats.

Samples were analyzed by METTLER TOLEDO DSC 823^{e} with a HUBER TC45 immersion cooling system.

10±1 mg of sample were hermetically sealed in a 40 μL aluminum pan, with an empty pan as reference. Samples were initially held at 20.0° C. for 2 min. Samples were then heated to 50.0° C. at 3° C./min to produce a melting thermogram.

In particular, symmetric mono-unsaturated triglycerides have the possibility to solidify in a number of different crystalline forms.

The higher the main endotherm melt peak position of a triglyceride blend, the more stable the crystalline form or forms present in the blend.

It has surprisingly been found that higher-melting crystal forms for vegetable fat or fractions thereof rich in SatOSat-triglycerides and with a substantial content of StOSt-triglycerides can be rapidly obtained by a method involving a melting step and storage under controlled temperature conditions.

The starting value referred to herein corresponds to DSC measurements taken prior to the storage step, that is, at 0 hours of storing the vegetable fat or fractions thereof at a temperature below said increased value of said main endotherm melt peak position.

In further embodiments the temperature applied in step b) is about 25° C. to about 39° C., such as about 27° C. to about 39° C., about 30° C. to about 39° C. or about 33° C. to about 38° C.

According to even further embodiments of the invention the storage temperature applied in step b) is higher than ambient. By storing the vegetable fat at temperatures higher than ambient, for example at 26° C., 28° C., 29° C., 31° C., 32° C., 34° C., 35° C., 36° C., 37° C. or at varying temperatures therein between, the formation of high-melting fat crystals is accelerated to a surprisingly high degree.

In an embodiment of the invention the method is further comprising a step a1) following step a) and prior to step b), said the step a1) consisting of cooling the vegetable fat or fractions thereof to a temperature of between about −30° C. and about 39° C., such as between about −10° C. and about 38° C. or between about 0° C. and about 37° C.

The cooling step may involve active cooling, for example when the melt is spray dried. The way of cooling is of less importance in these embodiments of the invention and can also involve letting the melted vegetable fat cool at, for example, ambient temperature to a temperature close to ambient, such as 19° C.-25° C.

In an embodiment of the invention said vegetable fat or fractions thereof comprises SatOSat in an amount of 50-93%, such as 60-90%.

It has surprisingly been found that higher-melting crystal forms for vegetable fat or fractions thereof rich in SatOSat-triglycerides may be rapidly obtained.

In an embodiment of the invention said vegetable fat or fractions thereof comprises StOSt in an amount of 40-80% by weight, such as 45-75% or 50-70%.

According to further embodiments of the invention a substantial content of StOSt-triglycerides promotes the surprisingly rapid formation of high-melting crystal in the vegetable fat or fractions thereof.

In an embodiment of the invention said vegetable fat or fractions thereof is selected from the group consisting of shea, sal, mango, mowra, kokum, illipe, cupuacu and any combination thereof.

According to further embodiments of the invention, the method is applicable to vegetable fat or fat fractions from a variety of natural sources.

In further embodiments of the invention said vegetable fat or fractions thereof comprises or consists of shea stearin.

Shea stearin is a fat fraction obtainable from shea kernels and has a fat composition suitable for successful processing according to embodiments of the invention.

In further embodiments of the invention said increased value of said main endotherm melt peak position is about 41° C. or higher, such as about 42° C. or higher or about 43° C. or higher.

According to embodiments of the invention, a main endotherm melt peak position is desirable that reflects a high amount of stable high-melting fat crystals. As such, a higher temperature reflects a higher melting vegetable fat comprising comparatively high amount of high-melting fat crystals. The storage time and storage temperature needed to achieve a desired increased value of the main endotherm melt peak position may also depend on the vegetable fat composition.

In an embodiment of the invention, shea stearin is subjected to the method of the present invention. The shea stearin is completely melted by applying heat to a temperature above about 40° C., such as 50° C. or 60° C. The melt is allowed to cool to a temperature below 40° C. and stored at a temperature of between 33° C. and 39° C. for at least 15, 16, 17 or 18 hours, whereby a main endotherm melt peak position of about 41° C. or higher, such as about 42° C. or higher is obtained. This main endotherm melt peak position corresponds to an increase of at least about 4° C. above the starting value of the main endotherm melt peak position at t=0 hours of storage.

In an embodiment of the invention said increased value of said main endotherm melt peak position is at least about 2° C., such as at least about 3° C. or at least about 4° C. above said starting value.

According to embodiments of the invention, the increase in main endotherm melt peak position is at least 2° C. when compared to the starting value measured before the storage of the vegetable fat. In applications such as the production of chocolate, incorporation of vegetable fat according to embodiments of the invention may improve the melting properties and the sensory properties of the final chocolate.

In an embodiment of the invention step b) of the method is performed for at least about 10 hours such as for at least about 14 hours or for at least about 18 hours. The main endotherm melt peak position after step b) should be about 40° C. or higher. Depending on the fat composition and the storage temperature, this may surprisingly be achieved already after several hours, such as at least 12 hours or at least 15 hours, at least 20 hours or at least 25 hours of storage at, for example, 39° C., such as 38° C., 35° C. or 34° C. or variations therein between. The fast increase of the main endotherm melt peak position is highly surprising. Slightly lower storage temperatures, for example, 23° C., 28° C., 30° C. or variations therein between may require slightly longer storage times to achieve a main endotherm melt peak position of about 40° C. or higher, again depending on the vegetable fat composition.

Further embodiments are wherein said method in any of its embodiments further comprises grinding the stored vegetable fat or fractions thereof with an increased main endotherm melt peak position, i.e. in a step b1) of the method above, to a powder. As used herein, grinding includes milling, rasping, mincing, cutting, breaking and chopping in any way to a powder.

Even further embodiments are wherein said method in any of its embodiments further comprises melting the stored vegetable fat or fractions thereof with an increased main endotherm melt peak position, i.e. in a step b1) of the method above, to a slurry. As used herein, a slurry is intended to mean a suspension of solid particles, including crystals, in a liquid or any fluid mixture of a pulverized solid with a liquid. A slurry herein includes a partially melted vegetable fat or fractions thereof.

The invention further relates to a chocolate product comprising the vegetable fat or fractions thereof manufactured according to the method of any of the embodiments described above.

Chocolate products may be considerably improved by applying the method of the present invention to a vegetable fat or fractions thereof and incorporating the so treated fat in chocolate products.

The invention also relates to use of the vegetable fat or fractions thereof manufactured according to the method of any of the embodiments described for production of chocolate products.

By applying the method of the present invention to a vegetable fat or fractions thereof and using the so treated fat as an ingredient in the manufacture of chocolate, the manufacturing process of the chocolate products may be simplified and/or the chocolate products may obtain improved properties with respect to, for example, sensory parameters and shelf life, especially at elevated temperatures.

The invention further relates to use of the vegetable fat or fractions thereof manufactured according to the method of any of the embodiments described for production of chocolate products, said vegetable fat or fractions thereof being used as a seed.

The vegetable fat or fractions thereof treated according to the method of the present invention is particularly useful for seeding purposes in the manufacture of chocolate products. Seeding with high-melting crystals obtained by the method of the present invention may assist formation of high-melting crystals in the chocolate during tempering or even make possible the omission of a tempering process, whereby the quality of the chocolate may be improved, and its production may be simplified.

Further embodiments of said use in any of its embodiments also include wherein said vegetable fat or fractions thereof is used as a powder or as a slurry. Particular embodiments are thus wherein said use of the vegetable fat or fractions thereof manufactured according to the method of any of the embodiments described herein is for production of chocolate products and wherein said vegetable fat or fractions thereof is used as a seed and wherein said seed is used as a powder or a slurry.

### FIGURES

FIGS. 1 and 2 show the effect of storage temperature and storage time on the main endotherm melt peak position.

FIG. 1 indicates the effect on the main endotherm melt peak position after 5 hours of isothermal storage at 20° C. and 37° C., respectively, the starting value being about 36.5° C.

Solid line: 20° C. for 5 hours. Dashed line: 37° C. for 5 hours.

FIG. 2 indicates the effect on the main endotherm melt peak position after 29 hours of isothermal storage at 20° C. and 37° C., respectively, the starting value being about 36.5° C.

Solid line: 20° C. for 29 hours. Dashed line: 37° C. for 29 hours.

### EXAMPLES

### Example 1

### Main Endotherm Melt Peak Position of Shea Stearin as a Function of Storage Time and Storage Temperature

DSC Analysis

Samples were analyzed by METTLER TOLEDO DSC 823^{e} with a HUBER TC45 immersion cooling system.

10±1 mg of sample were hermetically sealed in a 40 μL aluminum pan, with an empty pan as reference. Samples were initially held at 20.0° C. for 2 min. Samples were then heated to 50.0° C. at 3° C./min to produce a melting thermogram.

Experiments were performed in duplicate.

DSC Data

Procedure:

50 gram samples of Shea Stearin were cooled from 60° C. to 25° C. and thereafter placed in isothermal storage cabinets at 20±0.5° C., 25±0.5° C., 30±0.5° C., 33±0.5° C., 35±0.5° C. and 37±0.5° C., respectively.

Non-isothermal DSC thermograms were obtained at intervals between 0 hours (prior to insertion into isothermal cabinets) and 317 hours of storage in the isothermal cabinets.

The measurement at 0 h corresponds to the starting value referred to herein. Table 1 shows non-isothermal DSC thermogram melt peak positions after storage at different temperatures and for different times of storage.

TABLE 1
Non-isothermal DSC thermogram melt peak positions

Storage temperature/° C.

| Time/h | 20 | 25 | 30 | 33 | 35 | 37 |
|---|---|---|---|---|---|---|
| 0 | 36.5 | 36.5 | 36.5 | 36.5 | 36.5 | 36.5 |
| 5 | 37.6 | 36.4 | 36.4 | — | 38.8 | 38.8 |
| 13 | — | — | — | 37.1 | 39.0 | 38.9 |
| 19 | — | — | — | 37.4 | 42.6 | 42.7 |
| 24 | — | — | 37 | 37.8 | 42.6 | — |
| 29 | 37.4 | 38.0 | 37.8 | — | 43.2 | 43.2 |
| 48 | — | — | 37.6 | 42.1 | 43.6 | — |
| 72 | 37.2 | 38.6 | 37.6 | 42 | 43.3 | 43.7 |
| 149 | 37.2 | 39 | 42.9 | — | 43.5 | 43.3 |
| 317 | 37.6 | 40.7 | 42.9 | — | 43.3 | 43.6 |

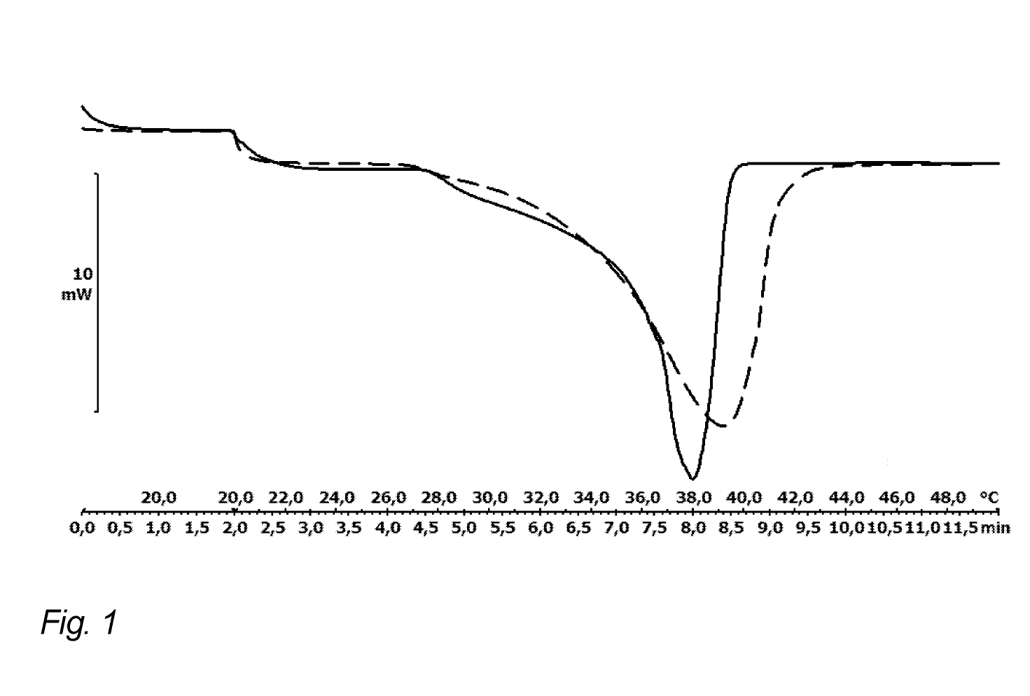

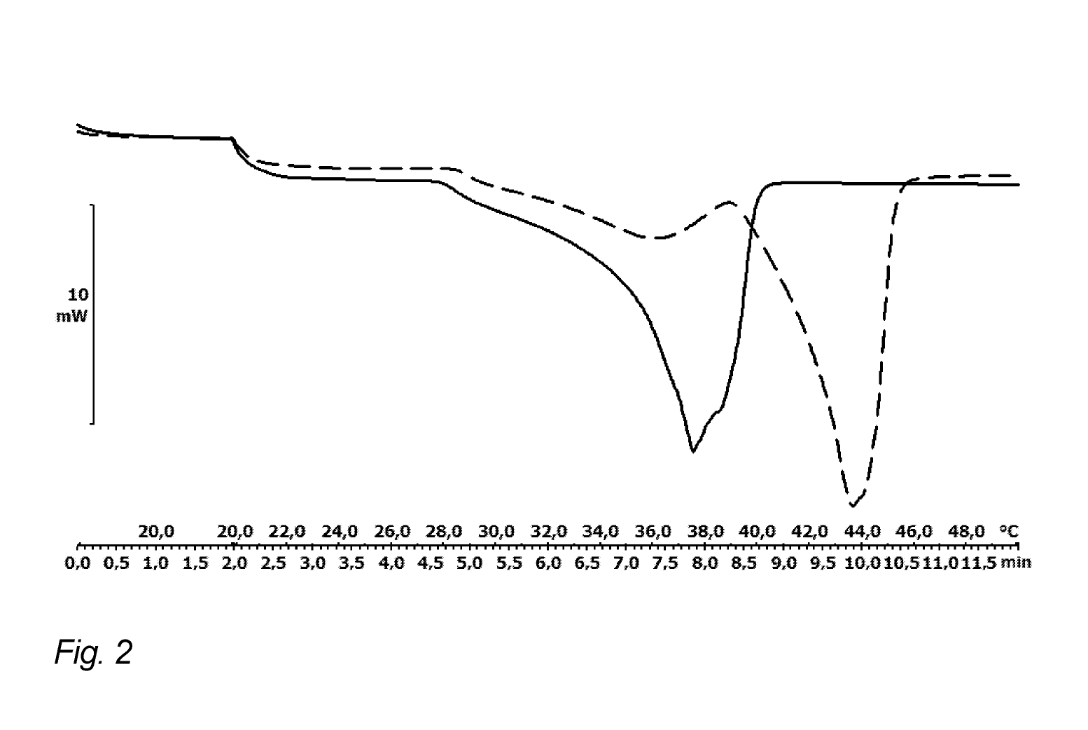

The results after 5 hours and 29 hours at 20° C. and 37° C., respectively, are shown in FIG. 1 and FIG. 2, respectively.

The results show that the main endotherm melt peak position is increased rapidly within hours or days of storage at the temperatures indicated.

The broadening of the peak representing 20° C. when going from FIG. 1 to FIG. 2 indicates beginning transformation of fat crystals into more stable forms.

Isothermal storage has been used for convenience during the experiments shown in the table, but storage at varying temperatures, such as between 20° C. and 39° C., will also promote the formation of high melting crystals in the vegetable fat, thereby increasing the main endotherm melt peak position when compared to the starting value a t=0 hours.

1. A method of increasing a main endotherm melt peak position of a vegetable fat or fractions thereof comprising:
a) melting the vegetable fat or fractions thereof by applying heat,
b) storing the vegetable fat or fractions thereof at a temperature below that of the increased main endotherm melt peak position for at least 5 hours, wherein said vegetable fat or fractions thereof comprise saturated fatty acid-oleic acid-saturated fatty acid-triglycerides in an amount of 40-95% by weight, and stearic acid-oleic acid-stearic acid-triglycerides in an amount of 30-85% by weight,
wherein said increase being about 40° C. or higher compared to a starting value, and said main endotherm melt peak position being defined via Differential Scanning Calorimetry wherein 10±1 mg samples of said vegetable fat or fractions are heated from 20° C. to 50° C. at a rate of 3° C./min to produce a melting thermogram.

2. The method according to claim 1, wherein the storage temperature applied in step b) is about 25° C. to about 39° C. higher than that of a starting value.

3. The method according to claim 1, further comprising a step a1) following step a) and prior to step b), said step a1) consisting of cooling the vegetable fat or fractions thereof to a temperature of between about −30° C. to about 39° C.

4. The method according to claim 1, wherein the vegetable fat or fractions thereof comprise saturated fatty acid-oleic acid-saturated fatty acid in an amount of 50-93% by weight.

5. The method according to claim 1, wherein the vegetable fat or fractions thereof comprise stearic acid-oleic acid-stearic acid in an amount of 40-80% by weight.

6. The method according to claim 1, wherein the vegetable fat or fractions thereof are chosen from shea, sal, mango, mowra, kokum, illipe, cupuacu and any combination thereof.

7. The method according to claim 1, wherein the vegetable fat or fractions thereof comprise shea stearin.

8. The method according to claim 1, wherein the increase in the main endotherm melt peak position is about 41° C. or higher than the starting value.

9. The method according to claim 1, wherein the increase in the main endotherm melt peak position is at least about 2° C. relative to the starting value.

10. The method according to claim 1, wherein the storage in step b) is performed for at least about 10 hours.

11. The method according claim 1, further comprising grinding the stored vegetable fat or fractions thereof to a powder.

12. The method according claim 1, further comprising melting the stored vegetable fat or fractions thereof to a slurry.

13. A chocolate product comprising the vegetable fat or fractions thereof manufactured according to the method of claim 1.

14. The method of using the vegetable fat or fractions thereof manufactured according to claim 1 for production of chocolate products.

15. The method according to claim 14, wherein the vegetable fat or fractions thereof are used as seeds.

16. The method according to claim 14, wherein the vegetable fat or fractions thereof are used as powder or slurry.

17. The method according to claim 1, wherein the storage temperature applied in step b) is about 27° C. to about 39° C. higher than that of a starting value.

18. The method according to claim 1, wherein the storage temperature applied in step b) is about 30° C. to about 39° C. higher than that of a starting value.

19. The method according to claim 1, wherein the storage temperature applied in step b) is about 33° C. to about 38° C. higher than that of a starting value.

20. The method according to claim 3, wherein step a1) consists of cooling the vegetable fat or fractions to a temperature of between about 10° C. to about 38° C.

21. The method according to claim 3, wherein step a1) consists of cooling the vegetable fat or fractions to a temperature of between about 0° C. to about 37° C.

22. The method according to claim 1, wherein the vegetable fat or fractions thereof comprise saturated fatty acid-oleic acid-saturated fatty acid in an amount of 60-90%.

23. The method according to claim 1, wherein the vegetable fat or fractions thereof comprise stearic acid-oleic acid-stearic acid in an amount of 45-70% by weight.

24. The method according to claim 1, wherein the vegetable fat or fractions thereof comprise stearic acid-oleic acid-stearic acid in an amount of 50-70% by weight.

25. The method according to claim 1, wherein the increase in the main endotherm melt peak position is about 42° C. or higher than the starting value.

26. The method according to claim 1, wherein the increase in the main endotherm melt peak position is about 43° C. or higher than the starting value.

27. The method according to claim 1, wherein the increase in the main endotherm melt peak position is at least about 3° C. relative to the starting value.

28. The method according to claim 1, wherein the increase in the main endotherm melt peak position is at least about 4° C. relative to the starting value.

29. The method according to claim 1, wherein the storage in step b) is performed for at least about 14 hours.

30. The method according to claim 1, wherein the storage in step b) is performed for at least about 18 hours.
